(19) United States
(12) Patent Application Publication
(10) Pub. No.: US 2011/0110636 A1
(43) Pub. Date: May 12, 2011

(54) Fiber Optic Cables Having Limited Strength Elements

(76) Inventor: Samuel D. Navé, Newton, NC (US)

(21) Appl. No.: 12/617,008

(22) Filed: Nov. 12, 2009

(51) Int. Cl. G02B 6/44; G02B 6/04

(52) U.S. Cl. 385/103; 385/115

(57) ABSTRACT

A fiber optic cable may include a jacket having an inner surface extending around and defining an interior space. The fiber optic cable may include an inner group of optical fibers positioned in the interior space, where each of the optical fibers of the inner group is positioned adjacent to a central lengthwise axis of the fiber optic cable. An outer group of optical fibers may be positioned in the interior space around the inner group of optical fibers and a strength material may be positioned in the interior space around the outer group of optical fibers. Each of the optical fibers may be configured in the cable to exhibit a crush-induced optical attenuation of less than 0.6 dB when the cable is subjected to a crushing force of about 220 Newtons per centimeter of cable length.

### BACKGROUND

The present disclosure generally relates to fiber optic cables and methods of manufacturing fiber optic cables.

The science of fiber optics is applicable to various fields of technology and is often used for the transmission of communication signals. Individual optical fibers, which each act as a waveguide for directing light from one end of the fiber to the other, can be bundled together to form a fiber optic cable.

Fiber optic cable can be installed outdoors over long distances, either underground or above ground, and can also be installed within buildings. When installed indoors, fiber optic cable may be run through the plenum spaces of buildings alongside HVAC equipment and other utilities. Fiber optic cable may also be run through riser spaces, such as elevator shafts or other spaces within a building.

When installing indoor-type fiber optic cable, it may be necessary at times to bend the cable around corners or other structures in a building. A bent fiber optic cable may cause the light within its optical fibers to be scattered or lost when the bend radius is too small. The scattering or loss of light is referred to herein as optical attenuation.

Another important mechanical property of cables is the resistance to crush under loads. A conventional crush test apparatus includes two rigid plates of 10 centimeter length. The plates are configured to exert compressive loads at a mid-span section of a cable. Edges of the plates can be rounded so that the plates do not cut into the surface of the cable. The load is applied for a specified time (e.g., 10 minutes), and then released. The optical delta attenuation caused by the crush load in the optical fibers of the cable is then measured.

Many cables include strength materials that not only function to strengthen the cables when they experience tensile and buckling forces, but also function to minimize the bend angle of the cable, which can help to reduce the optical attenuation.

### SUMMARY

The present disclosure describes fiber optic cables and methods of manufacturing fiber optic cables. According to some embodiments disclosed herein, a fiber optic cable may include a jacket having an inner surface extending around and defining an interior space. The fiber optic cable may include an inner group of optical fibers positioned in the interior space, where each of the optical fibers of the inner group is positioned adjacent to a central lengthwise axis of the fiber optic cable. An outer group of optical fibers may be positioned in the interior space around the inner group of optical fibers, and strength material may be positioned in the interior space around the outer group of optical fibers. Each of the optical fibers may be configured in the cable to exhibit a crush-induced optical attenuation of less than 0.6 dB when the cable is subjected to a crushing force of about 220 Newtons per centimeter of cable length.

In some implementations, a method of manufacturing a fiber optic cable may include stranding or otherwise arranging a first group of optical fibers together, stranding or otherwise arranging a second group of optical fibers around the first group of optical fibers, and stranding or otherwise arranging a strength material around the second group of optical fibers. The method may also include extruding a polymer jacket around the strength material. Each of the optical fibers may be configured in the cable to exhibit a crush-induced optical attenuation of less than 0.6 dB when the cable is subjected to a crushing force of about 220 Newtons per centimeter of cable length.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

The components of the following Figures are illustrated to emphasize the general principles of the present disclosure and are not necessarily drawn to scale.

FIG. 1 is a schematic cross-sectional view of a fiber optic cable according to a first embodiment of this disclosure, wherein the cross section is perpendicular to the length of the fiber optic cable.

FIG. 2 is a schematic cross-sectional view of a fiber optic cable according to a second embodiment of this disclosure, wherein the cross section is perpendicular to the length of the fiber optic cable.

FIG. 3 is an isolated, schematic cross-sectional view of a low attenuation optical fiber that may be representative of each of the optical fibers of FIGS. 1 and 2, wherein the cross section is perpendicular to the length of the low attenuation optical fiber.

FIG. 4 is a graph illustrating the refractive indices of the different concentric layers of the low attenuation optical fiber of FIG. 3.

FIG. 5 is a schematic cross-sectional view of a bundled cable according to a third embodiment of this disclosure, wherein the cross section is perpendicular to the length of the bundled cable.

### DETAILED DESCRIPTION

Some aspects of the present disclosure are directed to fiber optic cables containing a plurality of low attenuation optical fibers, particularly optical fibers with low delta attenuation under bend and/or crush, bundled cables containing a plurality of fiber optic cables, and methods of manufacturing fiber optic cables. According to various embodiments, the optical fibers described herein may be arranged in one layer, two layers, or more than two layers. Also, the amount of strength material used to strengthen fiber optic cables may be reduced while seeking to avoid a significant negative effect on optical attenuation. Using optical fibers that exhibit only a small amount of delta attenuation when bent or crushed, the amount of strength material can be reduced to allow for greater flexibility of the fiber optic cables. With more flexible cables, an installer may be able to install them more easily, particularly if installation requires bending the cables around corners or other structures in a building.

According to some embodiments described herein, the fiber optic cables have been tested for optical attenuation to determine that the bend radius can be as low as about three times the diameter of the cable while experiencing a tolerable optical attenuation not exceeding a predetermined threshold. For example, the fiber optic cables described herein may include low attenuation optical fibers, which, when wrapped one turn around a 7.5 mm mandrel in a wrap test, exhibit a bend-induced delta attenuation of less than about 0.6 dB. In some embodiments, the optical attenuation during such a test may be 0.08 dB or lower. Also, when subjected to a crush test, the low attenuation optical fibers may exhibit a crush-induced delta attenuation of less than 0.6 dB when the cable is crushed by a force of about 220 Newtons per cm of cable length.

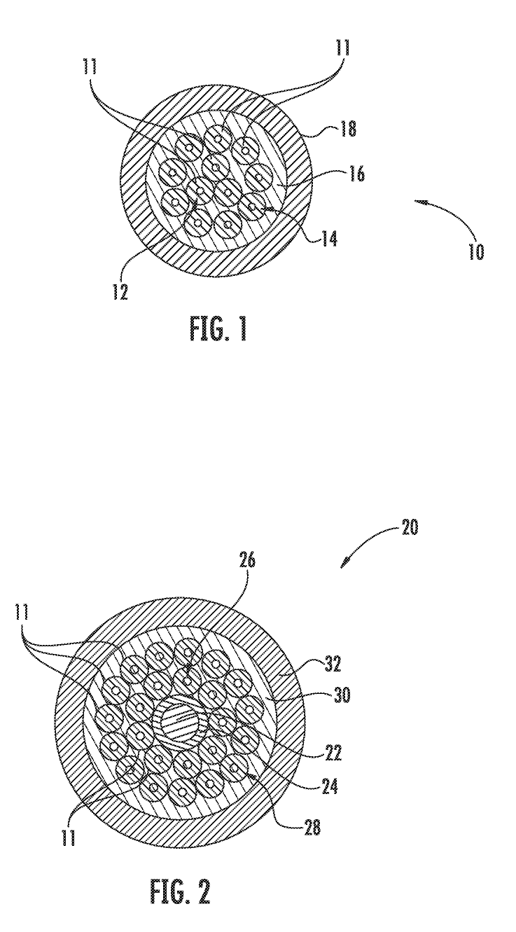

FIG. 1 is a schematic cross-sectional view of a fiber optic cable 10 according to a first embodiment of this disclosure. As illustrated, the cable 10 includes twelve optical fibers (e.g., at least twelve optical fibers), although the cable 10 may include other numbers of optical fibers. A representative few of the optical fibers are designated by the numeral 11 in FIG. 1. The cable 10 includes an inner layer 12 of the optical fibers 11 and an outer layer 14 of the optical fibers 11. The inner layer 12 of the optical fibers 11 may be stranded around the central lengthwise axis of the cable 10 or otherwise positioned around and along the central lengthwise axis of the cable 10. The outer layer 14 of the optical fibers 11 is positioned around (e.g., stranded around) the inner layer 12 of the optical fibers 11.

In accordance with the first embodiment, there are three (e.g., at least three) optical fibers 11 in the inner layer 12 and nine (e.g., at least nine) optical fibers 11 in the outer layer 14. In various embodiments, the number of layers of optical fibers 11 may be one, two, or more. Also, the cable 10 may include six, twelve, twenty-four, thirty-six, seventy-two, or more optical fibers 11 arranged in any number of layers.

As will be discussed in greater detail below, each of the optical fibers 11 may be a tight buffer low attenuation and/or bend tolerant optical fiber. More specifically in accordance with the first embodiment, and as will be discussed in greater detail below, each of the tight buffer bend tolerant optical fibers 11 may exhibit a bend-induced optical attenuation of less than or equal to about 0.6 dB when the cable 10 is bent to a bend radius of about 35 mm.

The cable 10 further comprises strength material 16 positioned around (e.g., stranded around) the outer layer of optical fibers 14, and a jacket 18 positioned around the strength material 16 (generally indicated by cross-hatching in the figures). The jacket 18 has an inner surface extending around and defining an interior space. The optical fibers 11 and strength material 16 are positioned in the interior space that the inner surface of the jacket 18 extends around.

The strength material 16 may include aramid (e.g., strands of aramid) or other suitable type of material. Although incorporated for strength, the strength material 16 typically allows the fibers 11 to move within the interior space that the jacket 18 extends around. In accordance with the first embodiment, some of the strength material 16 may be positioned between (e.g., stranded between) the two layers 12, 14. However, the strength material 16 between the two layers 12, 14 may be omitted. For example, the outer layer 14 of optical fibers 11 may be positioned immediately adjacent to the inner layer 12 of optical fibers 11, leaving little or no space for any strength material between the two layers 12, 14.

The jacket 18 is typically a polymeric member that is extruded around the strength material 16. Any suitable jacket 18 may be used. For example, the jacket 18 may be configured to meet certain standards, fire codes, burn codes, or other regulations, such as those for defining the acceptable materials and construction of fiber optic cables for use in plenum spaces or riser spaces. For example and not limitation, the jacket 18 may be PVC or PVDF. In one example, the jacket 18 is PVDF. In another example, where the cable 10 is part of a bundled cable as discussed in greater detail below, the jacket 18 is PVC. The jacket 18 may include or consist essentially of a polymer material that meets burn rating standards for low-smoke zero-halogen (LSZH), such as polyethylenes, polyolefins, polypropylenes and ethylene/vinyl acetate (EVA).

A rip cord (not shown) may optionally be included in the interior space that the jacket 18 extends around. If the rip cord is included, typically the jacket 18 is extruded around the rip cord so that the rip cord is adjacent the inner surface of the jacket.

In accordance with the first embodiment, in the region between the optical fibers of the inner layer 12, the cable 10 substantially does not include any of the strength material 16 or any other central strength member. By minimizing the size of or completely omitting such a central strength member, the arrangement of optical fibers 11 can be more compact. A compact arrangement of optical fibers 11 can decrease the overall size (e.g., diameter) of the jacket 18 and thus reduce material costs. Nonetheless, an adequate space can still be available to allow the optical fibers 11 to move within the cable 10, if desired.

In accordance with the first embodiment, the total number of optical fibers 11 is twelve (e.g., at least twelve). For example, the inner layer 12 consists of three (e.g., at least three) optical fibers 11 positioned immediately adjacent to one another and typically immediately adjacent to the central axis of the cable 10, and the outer layer 14 consists of nine (e.g., at least nine) optical fibers 11 stranded or otherwise positioned around the inner layer 12. The inner layer 12 or group of optical fibers 11 may be positioned immediately adjacent to the outer layer 14 or group of optical fibers 11. With the twelve optical fibers 11 (e.g., at least twelve optical fibers 11) in the cable 10, an average outer diameter of the jacket 18 may be less than or equal to about 7.3 mm, less than or equal to about 7.0 mm, or even less than or equal to about 6.4 mm.

When the cable 10 is installed, it may be bent. It is believed that the bend radius of the cable 10 can be as low as about three times the diameter of the cable 10, without there being too much optical attenuation for many applications.

Whereas the cable 10 of the first embodiment typically does not include any of the strength material 16 or any other central strength member that is positioned between the optical fibers 11 of the inner layer 12 at the central, lengthwise axis of the cable 10, it is within the scope of this disclosure for there to be strength material 16 and/or another centrally located strength member (e.g., a central strength member) that is positioned between the optical fibers 11 of the inner layer 12 at the central, lengthwise axis of the cable 10. For example and in accordance with an alternative embodiment of this disclosure, the cable 10 may include some of the strength material 16 or another strength material (e.g., a central strength member) that is positioned between the optical fibers 11 of the inner layer 12 at the central, lengthwise axis of the cable 10.

As another example, FIG. 2 is a schematic cross-sectional view of a fiber optic cable 20 with a central strength member (e.g., members 22, 24), in accordance with a second embodiment of this disclosure. The first and second embodiments of this disclosure are alike one another, except for variations noted and variations that will be apparent to one of ordinary skill in the art. For example, a representative few of the optical fibers are also designated by the numeral 11 in FIG. 2.

In accordance with the second embodiment, the central strength member of the cable 20 typically extends centrally along the entire length of the cable 20 and includes a glass-reinforced plastic (GRP) member 22, which is located at the core of the central strength member, and a PVC member 24 (e.g., overcoat), which substantially coaxially surrounds the GRP member 22. Other polymer materials can be used for the member 24, such as polyethylene, PVDF, FRPE, etc. Each of the GRP and PVC members 22, 24 typically extends along the entire length of the cable 20. Alternatively, the central strength member of the cable 20 may include only GRP, only PVC, or any other suitable strength material(s) and member(s) (e.g., central strength members) may be used.

The cable 20 also includes an inner layer 26 of optical fibers 11 and an outer layer 28 of optical fibers 11. The inner layer 26 of optical fibers 11 is positioned around (e.g., stranded around) the central strength member (e.g., members 22, 24). The outer layer 28 of optical fibers 11 is positioned around (e.g., stranded around) the inner layer 26 of optical fibers 11. Strength material 30 (e.g., strands of aramid or any other suitable material) is positioned around (e.g., stranded around) the outer group of optical fibers 28. Some of the strength material 30 may also be positioned between (e.g., may be stranded between) the two layers 26, 28. However, the strength material 30 between the two layers 26, 28 may be omitted. For example, the outer layer 28 of optical fibers 11 may be positioned immediately adjacent to the inner layer 26 of optical fibers 11, leaving little or no space for any strength material between the two layers 26, 28.

The cable 20 further includes a jacket 32 positioned around the strength material 30. The jacket 32 has an inner surface extending around and defining an interior space. The optical fibers 11 and strength material 30 are positioned in the interior space that the inner surface of the jacket 32 extends around.

Even though the cable 20 includes the central strength member (e.g., members 22, 24), the size of the central strength member may be relatively small in comparison with the central strength members of conventional cables. As a result, cable 20 may be bent more easily.

As shown in FIG. 2 and in accordance with the second embodiment, the cable 20 may includes a total of twenty-four optical fibers 11, although other numbers of optical fibers may be included. With twenty-four optical fibers 11 (e.g., at least twenty-four optical fibers 11), the average outer diameter of the jacket 32 may be less than about 10.9 mm, less than or equal to about 10.5 mm, or less than or equal to about 8.4 mm.

Regarding the interior space that the inner surface of the jacket 32 extends around, the central strength member (e.g., the combination of the members 22, 24) may occupy less than about 33.4% of the interior space, less than about 13.7% of the interior space, less than about 5.0% of the interior space, less than or equal to about 2.0% of the interior space, or less than about 1.0% of the interior space. Further regarding the interior space that the inner surface of the jacket 32 extends around, the central strength member (e.g., the combination of the members 22, 24) may occupy less than or equal to about 12.0% of the interior space, or less than or equal to about 4.6% of the interior space. The GRP member 22 may occupy less than about 4.8% of the interior space, less than about 3.5% of the interior space, less than or equal to about 2.0% of the interior space, or less than or equal to about 1.4% of the interior space. The diameter of the central strength member (e.g., the combination of the members 22, 24) may be less than or equal to about 2.7 mm, and the diameter of the GRP member 22 may be less than or equal to about 1.6 mm.

In accordance with the first and second embodiments, each of the optical fibers 11 exhibits relatively low attenuation. The low attenuation of the optical fibers 11 may include low intrinsic attenuation and/or low delta attenuation in bending. Intrinsic attenuation refers to optical attenuation exhibited under low stress conditions, such as the attenuation over 1 km of straight optical fiber/cable. For example, each of the optical fibers 11 may have an intrinsic attenuation of less than or equal to about 3.0 dB/km at 850 nm.

Delta attenuation refers to optical attenuation exhibited when the optical fiber/cable is subjected to certain stress conditions, such as crushing forces, bending forces, tensile forces, bend performance tests, crush performance tests, or tensile tests. As an example for delta attenuation, for each of the optical fibers 11 in isolation, when wrapped one turn around a 7.5 mm mandrel, the optical fiber may have a delta attenuation of less than or equal to about 0.6 dB, less than or equal to about 0.2 dB, or less than or equal to about 0.08 dB. Each of the optical fibers 11 may be configured in the cable to exhibit a crush-induced optical attenuation of less than about 0.6 dB when the cable is subjected to a crushing force of about 220 Newtons per cm of cable length, or a crush-induced optical attenuation of less than or equal to about 0.2 dB when subjected to a crushing force of about 220 Newtons per cm, or a crush-induced optical attenuation of less than or equal to about 0.08 dB when subjected to a crushing force of about 220 Newtons per cm. Each of the optical fibers 11 may exhibit a temperature cycling optical attenuation of less than 0.6 dB when subjected to a temperature of about −40° C., or a temperature cycling optical attenuation of less than 0.6 dB when subjected to a temperature of about −50° C.

In accordance with the first and second embodiments, each of the optical fibers 11 is a tight buffered bend tolerant optical fiber. In one specific example, the low attenuation optical fibers 11 may be ClearCurve™ brand multimode optical fibers, or more specifically tight buffered ClearCurve™ brand multimode optical fibers, available from Corning Cable Systems of Hickory, N.C., and Corning Inc., of Corning, N.Y., although any other suitable optical fibers may be used.

As schematically shown in FIGS. 1 and 2, each of the tight buffered low attenuation optical fibers 11 includes a tight buffer extending around a bend tolerant optical fiber. For each of the optical fibers 11, the tight buffer is typically a substantially cylindrical, outer extrusion of polymeric material (e.g., PVC) that extends substantially coaxially around and is fixedly connected to the central low attenuation optical fiber.

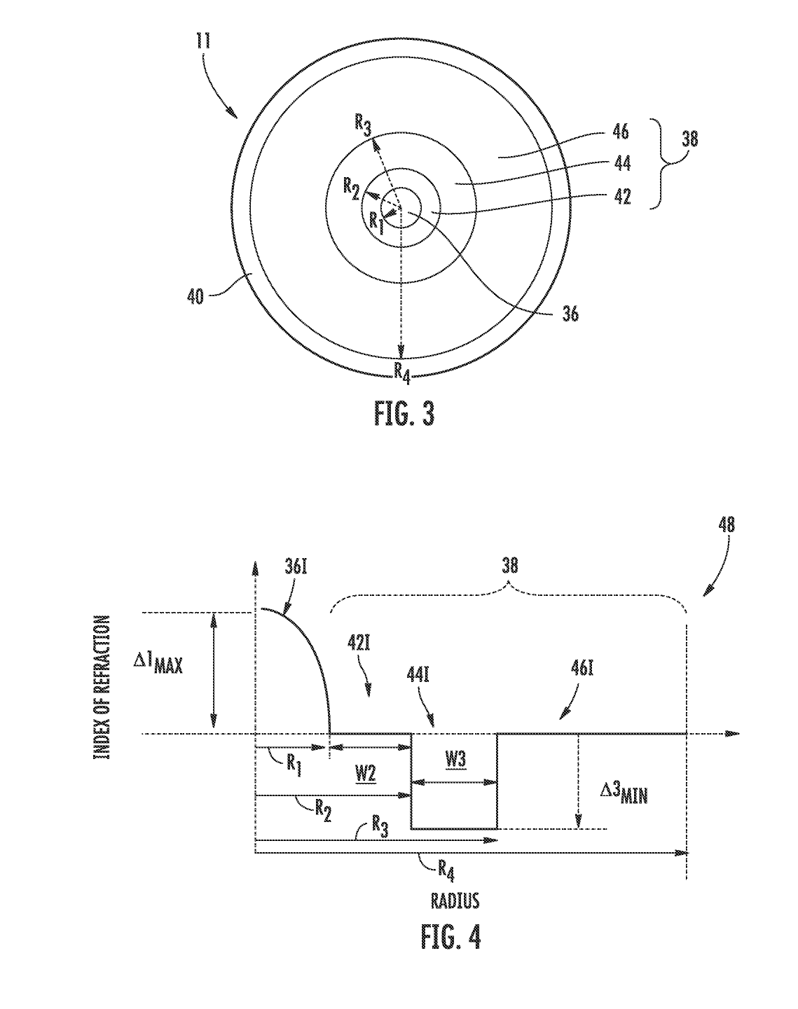

FIG. 3 is an isolated, schematic cross-sectional view of one of the bend tolerant optical fibers 11 without its outer tight buffer, or showing the outer tight buffer with a reduced thickness, in accordance with the first and second embodiments. The following discussion of the representative low attenuation optical fiber 11 is applicable to each of the other optical fibers 11. Whereas a specific example of a suitable low attenuation optical fiber 11 is described in the following, any other suitable optical fibers may be used.

Referring to FIG. 3, the low attenuation optical fiber 11 includes a core 36 and a cladding 38 that surrounds and is directly adjacent to the core 36. The cladding 38 includes an inner layer 42, a middle layer 44, and an outer layer 46. In some embodiments, the cladding 38 may have an overall radius of about 125 μm.

Generally, the index of refraction of the core 36 is graded from a high index of refraction at a central point to a medium index at an outer point. For example, the core 36 may comprise a graded glass or other suitable material for radially varying the index of refraction. The inner layer 42 includes a medium index of refraction, the middle layer 44 includes a low or depressed index or refraction, and the outer layer 46 includes a medium index of refraction. To achieve a low index of refraction, the middle layer 44 may comprise, for example, fluorine, boron, combinations of fluorine and boron, glass having a plurality of voids, glass doped with one or more down-dopants, such as fluorine, boron, or mixtures thereof, or other compositions or mixtures. In some embodiments, the depressed-index of the middle layer 44 of the cladding 38 may be spaced apart from the core 36 by the inner layer 42.

The middle layer 44 may have a width of at least about 1 μm and may comprise a substantially consistent material composition throughout, such that its refractive index may vary by less than about 0.2% across its width. The middle layer 44 may be spaced from the core 36 by the inner layer 42 or other suitable gap of at least about 0.5 μm. Therefore, the width of the inner layer 42 may be at least about 0.5 μm.

To achieve a low attenuation, the core 36 may be configured with a relatively high index of refraction, the inner layer 42 may be configured with a medium index of refraction, the middle layer 44 may be configured with a relatively low index of refraction, and the outer layer 46 may be configured with a medium index of refraction. The composition of the low attenuation optical fiber 11 exhibits a low amount of intrinsic optical attenuation and a low amount of delta attenuation even when bent.

The core 36 may have a graded index of refraction in which the index of refraction varies in a gradual, linear, exponential, or other manner from a centermost portion of the core 36 to an outermost portion of the core 36. In some implementations, the refractive index profile of the core 36 can have a parabolic or other curved shape. The middle layer 44 of the cladding 38 may comprise a refractive index relatively depressed compared with the inner layer 42 and outer layer 46 of the cladding 38. Also, the depressed-index middle layer 44 may have a refractive index delta less than about 0.2% along its width when its width is at least about 1 μm.

In some embodiments, the low attenuation optical fiber 11 may be constructed as a single-mode fiber (SMF), which limits the light that can enter the fiber to a single mode (or self-consistent electric field distribution). As an example, the core 36 of an SMF may have a diameter of about 8-9 μm. In some embodiments, the low attenuation optical fiber 11 may be constructed as a multimode fiber (MMF), which receives light from multiple angles to allow multiple modes of light. As an example, the core 36 of a MMF may have a diameter of about 50 μm, 62.5 μm, 100 μm, or other suitable diameter. For MMF, the diameter of the core 36 of the low attenuation optical fiber 11 may be about 50 μm.

In some embodiments, the cladding 38 may contain voids. The voids according to various implementations may be non-periodically or randomly located within the middle layer 44. Also, the size, shape, and distribution of the voids may be variable. In some embodiments, the voids may extend less than one meter along the length of the low attenuation optical fiber 11.

The low attenuation optical fiber 11 disclosed herein exhibits very low bend-induced optical attenuation, in particular very low macro-bending induced optical attenuation. In some embodiments, high bandwidth is provided by low maximum relative refractive index in the core 36, and low bend losses are also provided.

The low attenuation optical fiber 11 may further exhibit a one-turn, 10 mm diameter mandrel wrap optical attenuation increase of less than or equal to about 0.4 dB/turn at 850 nm, a numerical aperture (NA) of greater than 0.14, greater than 0.17, greater than 0.18, or even greater than 0.185, and an overfilled bandwidth greater than 1.5 GHz-km at 850 nm.

The core 36 may be configured to provide an overfilled (OFL) bandwidth of greater than 1.5 GHz-km, greater than 2.0 GHz-km, greater than 3.0 GHz-km, or even greater than 4.0 GHz-km at an 850 nm wavelength. These high bandwidths can be achieved while still maintaining a one-turn, 10 mm diameter mandrel wrap optical attenuation increase at an 850 nm wavelength of less than 0.5 dB, less than 0.3 dB, less than 0.2 dB, or even less than 0.15 dB. These high bandwidths can also be achieved while also maintaining a one-turn, 20 mm diameter mandrel wrap optical attenuation increase at an 850 nm wavelength of less than 0.2 dB, less than 0.1 dB, or even less than 0.05 dB, and a one-turn, 15 mm diameter mandrel wrap optical attenuation increase at an 850 nm wavelength, of less than 0.2 dB, less than 0.1 dB, or even less than 0.05 dB.

The low attenuation optical fiber 11 is further capable of providing a numerical aperture (NA) greater than 0.17, greater than 0.18, or even greater than 0.185. The low attenuation optical fiber 11 is further simultaneously capable of exhibiting an OFL bandwidth at 1300 nm which is greater than about 500 MHz-km, greater than about 600 MHz-km, or even greater than about 700 MHz-km. Such low attenuation optical fiber 11 are further simultaneously capable of exhibiting minimum calculated effective modal bandwidth (Min EMBc) of greater than about 1.5 MHz-km, greater than about 1.8 MHz-km, or even greater than about 2.0 MHz-km at 850 nm.

When configured as MMF, the low attenuation optical fiber 11 disclosed herein exhibits a spectral optical attenuation of less than 3 dB/km at 850 nm, less than 2.5 dB/km at 850 nm, less than 2.4 dB/km at 850 nm, or even less than 2.3 dB/km at 850 nm. The MMF fibers disclosed herein exhibit a spectral optical attenuation of less than 1.0 dB/km at 1300 nm, less than 0.8 dB/km at 1300 nm, or even less than 0.6 dB/km at 1300 nm. In some embodiments, the NA of the low attenuation optical fiber 11 is less than 0.23 and greater than 0.17 or even greater than 0.18, or even less than 0.215 and greater than 0.185.

FIG. 4 is a graph 48 illustrating a schematic representation of a refractive index profile of the concentric layers of the low attenuation optical fiber 11 shown in FIG. 3, in accordance with the first and second embodiments. The graph 48 shows the index of refraction of the low attenuation optical fiber 11 at different radii from a central point of the low attenuation optical fiber 11. A first radius R₁ represents the core 36, a second radius R₂ extends to the outer surface of the inner layer 42 of the cladding 38, and so on. The portion of the graph 48 representing the index of refraction of the core 36 is referenced as 36I, the portion of the graph representing the index of refraction of the inner cladding layer 42 is referenced as 42I, and so on.

As illustrated, the depressed-index middle layer 44I is offset from the core 36I and is surrounded by outer layers 42I and 46I. In some embodiments, the core 36 extends radially outwardly from a centerline to a radius R1, wherein 10≦R1≦40 μm, or 20≦R1≦40 μm. In some embodiments, 22≦R1≦34 μm. In some embodiments, the radius of the core 36 is between about 22 to 28 μm. In some embodiments, the radius of the core 36 is between about 28 to 34 μm.

In some embodiments, the core 36 has a maximum relative refractive index delta less than or equal to 1.2% and greater than 0.5% or even greater than 0.8%. In other embodiments, the core 36 has a maximum relative refractive index delta less than or equal to 1.1% and greater than 0.9%.

In some embodiments, the low attenuation optical fiber 11 exhibits a 1 turn, 10 mm diameter mandrel optical attenuation increase of no more than 1.0 dB, no more than 0.6 dB, no more than 0.4 dB, no more than 0.2 dB, or even no more than 0.1 dB, at all wavelengths between 800 nm and 1400 nm.

Referring again to FIG. 3, the core 36 and cladding 38 may contain glass or other suitable optically transparent material. The core 36 has radius R₁ and a maximum refractive index delta Δ1MAX. The inner layer 42 has width W2 (equal to R₂−R₁) and outer radius R₂. Middle layer 44 has a minimum refractive index delta percent Δ3MIN, width W3 (equal to R₃−R₂) and outer radius R₃. As illustrated, the middle layer 44 is offset or spaced away from the core 36 by the inner layer 42. The middle layer 44 surrounds and contacts the inner layer 42. The outer layer 46 surrounds and contacts the middle layer 44.

As best understood with reference to FIG. 3, the cladding 38 is surrounded by at least one coating 40, which may in some embodiments comprise a low modulus primary coating and a high modulus secondary coating. The coating 40 is typically surrounded by the tight buffer (not shown in FIG. 3) that is typically an outermost extrusion of polymeric material (e.g., PVC) that extends around and is fixedly connected to the coating 40. Alternatively, the coating 40 may be thicker than shown in FIG. 3, such that the coating is the outermost tight buffer. That is, the coating 40 may be characterized as schematically illustrating the outermost tight buffer. The outermost tight buffer typically has an outer diameter of about 0.9 mm.

In some embodiments, the inner layer 42 has a refractive index profile Δ2(r) with a maximum relative refractive index Δ2MAX, and a minimum relative refractive index Δ2MIN, and in some embodiments Δ2MAX=Δ2MIN. The depressed-index layer 44 has a refractive index profile Δ3(r) with a minimum relative refractive index Δ3MIN. The outer layer 46 has a refractive index profile Δ4(r) with a maximum relative refractive index Δ4MAX, and a minimum relative refractive index Δ4MIN, where in some embodiments Δ4MAX=Δ4MIN. In some embodiments, Δ1MAX>Δ2MAX>Δ3MIN. In some embodiments, the inner layer 42 has a substantially constant refractive index profile with a constant Δ2(r); in some embodiments, Δ2(r)=0%. The outer layer 46 may have a substantially constant refractive index profile, with a constant Δ4(r); in some of these embodiments, Δ4(r)=0%.

The core 36 may have an entirely positive refractive index profile, where Δ1(r)>0%. R1 is defined as the radius at which the refractive index delta of the core 36 first reaches a value of 0.05% or other value, going radially outwardly from the centerline. In some embodiments, the core 36 contains little or no fluorine. In some embodiments, the inner layer 42 may have a relative refractive index profile Δ2(r) having a maximum absolute magnitude less than 0.05%, and Δ2MAX<0.05% and Δ2MIN>−0.05%, and the depressed-index layer 44 begins where the relative refractive index of the cladding first reaches a value of less than −0.05%, going radially outwardly from the centerline. In some embodiments, the outer layer 46 has a relative refractive index profile Δ4(r) having a maximum absolute magnitude less than 0.05%, and Δ4MAX<0.05% and Δ4MIN>−0.05%, and the depressed-index layer 44 ends where the relative refractive index of the cladding first reaches a value of greater than −0.05%, going radially outwardly from the radius where Δ3MIN is found.

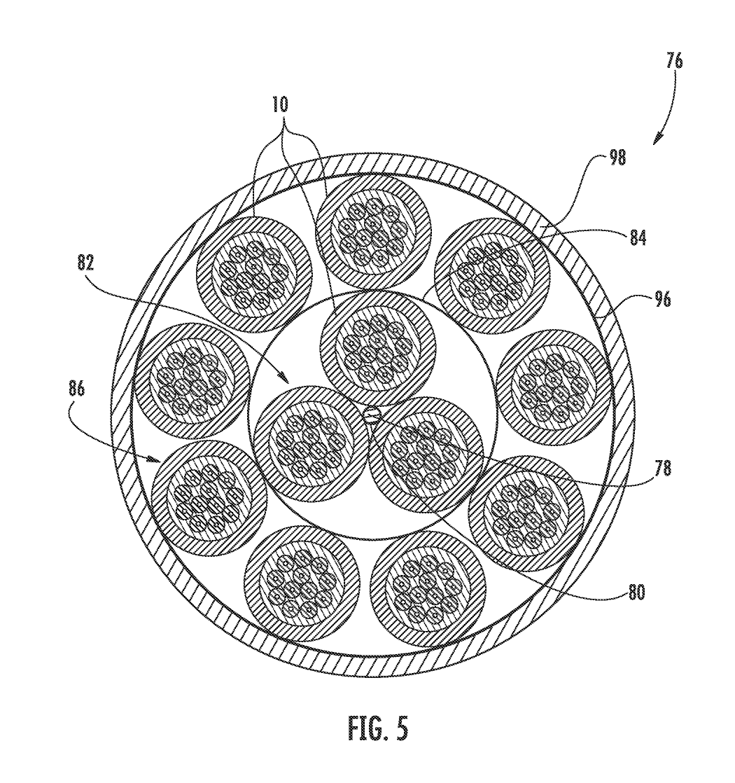

The cables of this disclosure (e.g., cables 10 and 20) may be bundled together in any suitable number and manner to form bundled cables. For example, FIG. 5 is a schematic cross-sectional view of a bundled cable 76 according to a third embodiment of this disclosure. The bundled cable 76 includes a central strength member 78. The central strength member 78 may be like the above-discussed central strength member of the cable 20 (FIG. 2), or may be any other type of suitable central strength member. For example, the central strength member 78 may include a glass-reinforced plastic (GRP) member surrounded by a PVC extrusion. Water-swellable yarn 80, tape or any other suitable material may be positioned around (e.g., wrapped or stranded around) the central strength member 78.

In the bundled cable 76, a group of (e.g., three of, or at least three of) the cables 10 (FIG. 1) (e.g., cable units) of the first embodiment, or any other suitable cables, may be positioned around (e.g., stranded around) the water swell yarn 80 to form an inner layer 82 of the cables 10. A layer of water swell tape 84 or any other suitable material may be positioned around (e.g., wrapped or stranded around) the inner layer 82 of the cables 10. A group of (e.g., nine of, or at least nine of) the cables 10 of the first embodiment (e.g., cable units), or any other suitable cables, may be positioned around (e.g., stranded around) the water swell tape 84 to form an outer layer 86 of the fiber optic cables 10. In accordance with the third embodiment, there are three cables 10 in the inner layer 82, and nine cables 10 in the outer layer, so that there are one hundred and forty-four fibers 11 in the bundled cable 76, although different numbers and arrangements are within the scope of this disclosure.

A layer of water swell tape 96 or any other suitable material may be positioned around (e.g., wrapped or stranded around) the outer layer 86 of the fiber optic cables 10. An outer jacket 98 in the form of a polymeric member is extruded around the tape 96. Any suitable outer jacket 98 may be used. For example, the outer jacket 98 may be configured to meet certain standards, fire codes, burn codes, or other regulations, such as those for defining the acceptable materials and construction of fiber optic cables for use in plenum spaces or riser spaces. For example and not limitation, the outer jacket 98 may be PVC or PVDF. Typically the outer jacket 98 will be PVDF, although any other suitable material may be used. The outer jacket 98 may also include or consist essentially of a polymer material that meets burn rating standards for low-smoke zero-halogen (LSZH).

The outer jacket 98 has an inner surface that extends around and defines an interior space of the bundled cable 76, so that the outer jacket 98 extends around the other components of the bundled cable 76. In accordance with the third embodiment, an average outer diameter of the outer jacket 98 may be less than or equal to about 27.0 mm, or less than or equal to about 25.1 mm. Regarding the interior space that the inner surface of the outer jacket 98 extends around, the central strength member 78 may occupy less than about 12.2% of the interior space, less than or equal to about 5.0% of the interior space, or less than or equal to about 0.25% of the interior space. In some embodiments, the central strength member 78 may comprise glass-reinforced plastic (GRP) coated with polyvinyl chloride (PVC). The GRP portion of the central strength member 78 may have a diameter of less than or equal to about 1.6 mm and occupy less than about 4.4% of the interior space that the inner surface of the jacket 98 extends around. More specifically, the GRP portion of the central strength member 78 may have a diameter of less than or equal to about 1.0 mm and occupy less than about 1.9% of the interior space that the inner surface of the jacket 98 extends around.

Throughout the foregoing disclosure, the adjective “about” has been used in numerous locations preceding an amount. Other embodiments of this disclosure are like the above-discussed embodiments, except that the adjective “about” is optional and may be omitted.

It will be apparent to those skilled in the art that various modifications and variations can be made without departing from the spirit or scope of the invention.

I claim:

1. A fiber optic cable comprising:
a jacket having an inner surface extending around and defining an interior space;
an inner group of optical fibers positioned in the interior space, each of the optical fibers of the inner group being positioned adjacent to a central lengthwise axis of the fiber optic cable;
an outer group of optical fibers positioned in the interior space around the inner group of optical fibers; and
strength material positioned in the interior space around the outer group of optical fibers, wherein
each of the optical fibers is configured in the cable to exhibit a crush-induced optical attenuation of less than 0.6 dB when the cable is subjected to a crushing force of about 220 Newtons per cm of cable length.

2. The fiber optic cable of claim 1, wherein the inner group of optical fibers is positioned immediately adjacent to the outer group of optical fibers.

3. The fiber optic cable of claim 1, wherein each of the optical fibers is a tight buffered multimode optical fiber.

4. The fiber optic cable of claim 1, wherein there are at least twelve of the optical fibers in the fiber optic cable.

5. The fiber optic cable of claim 4, wherein an average outer diameter of the jacket is less than or equal to about 7.3 mm.

6. The fiber optic cable of claim 4, wherein each of the optical fibers exhibits a bend-induced optical attenuation of less than or equal to about 0.6 dB when the fiber optic cable is bent to a bend radius of about 35 mm.

7. The fiber optic cable of claim 4, wherein the inner group comprises three of the optical fibers that are positioned immediately adjacent to one another.

8. The fiber optic cable of claim 4, further comprising a central strength member positioned in the interior space and occupying less than about 13.7% of the interior space.

9. The fiber optic cable of claim 8, wherein the central strength member occupies less than or equal to about 2.0% of the interior space.

10. The fiber optic cable of claim 8, wherein:
the central strength member comprises a glass-reinforced plastic (GRP) core with an overcoat; and
the GRP core occupies less than 4.8% of the interior space.

11. The fiber optic cable of claim 10, wherein the diameter of the central strength member is less than or equal to about 2.7 mm, and the diameter of the GRP core is less than or equal to about 1.6 mm.

12. A fiber optic cable comprising:
a jacket having an inner surface extending around and defining an interior space of the fiber optic cable;
a central strength member positioned in the interior space;
an inner group of optical fibers positioned in the interior space around the central strength member;
an outer group of optical fibers positioned in the interior space around the inner group of optical fibers; and
a strength material positioned in the interior space around the outer group of optical fibers, wherein
each of the optical fibers is configured in the cable to exhibit a crush-induced optical attenuation of less than 0.6 dB when the cable is subjected to a crushing force of about 220 Newtons per cm of cable length, and
wherein the central strength member occupies less than about 33.4% of the interior space.

13. The fiber optic cable of claim 12, wherein the central strength member occupies less than or equal to 12.0% of the interior space.

14. The fiber optic cable of claim 12, wherein each of the optical fibers is configured in the cable to exhibit a crush-induced optical attenuation of less than or equal to 0.2 dB when the cable is subjected to a crushing force of about 220 Newtons per cm of cable length.

15. The fiber optic cable of claim 12, wherein the central strength member comprises glass-reinforced plastic, and the glass-reinforced plastic occupies less than 3.5% of the interior space.

16. The fiber optic cable of claim 15, wherein the central strength member occupies less than or equal to about 12.0% of the interior space, and the glass-reinforced plastic occupies less than or equal to about 2.0% of the interior space.

17. The fiber optic cable of claim 12, wherein there are at least 24 of the optical fibers in the fiber optic cable, and an average outer diameter of the jacket is less than about 10.9 mm.

18. A bundled fiber optic cable comprising:
a central strength member;
a plurality of cable units positioned around the central strength member, each cable unit comprising a jacket extending around a plurality of optical fibers; and
an outer jacket surrounding the plurality of cable units, the outer jacket having an inner surface extending around and defining an interior space, wherein
the central strength member occupies less than about 12.2% of the interior space.

19. The bundled fiber optic cable of claim 18, wherein each of the optical fibers is configured in the cable to exhibit a crush-induced optical attenuation of less than or equal to 0.2 dB when the cable is subjected to a crushing force of about 220 Newtons per cm of cable length.

20. The bundled fiber optic cable of claim 18, wherein there are at least 12 of the cable units in the bundled fiber optic cable, and each of the cable units includes at least 12 of the optical fibers.

21. The bundled fiber optic cable of claim 20, wherein nine of the cable units are arranged in an outer layer around three of the cable units in an inner layer.
